(19) United States
(12) Patent Application Publication
(10) Pub. No.: US 2026/0195972 A1
(43) Pub. Date: Jul. 9, 2026

(54) TECHNIQUES FOR IMAGE RENDERING USING TRIANGLE PRIMITIVES

(71) Applicant: Apple Inc., Cupertino, CA (US)

(72) Inventors: Martin Danelljan, Mountain View, CA (US); Jan H. Bockert, Sunnyvale, CA (US); Manfred I. Hallstrom, Stockholm (SE)

(73) Assignee: Apple Inc., Cupertino, CA (US)

(21) Appl. No.: 19/444,871

(22) Filed: Jan. 9, 2026

Related U.S. Application Data
(60) Provisional application No. 63/743,346, filed on Jan. 9, 2025.

(51) Int. Cl. G06T 15/08; G06T 15/06; G06T 15/10; G06T 15/50

(52) U.S. Cl. CPC G06T 15/08; G06T 15/06; G06T 15/10; G06T 15/503; G06T 2210/21; G06T 2210/52

(57) ABSTRACT

Techniques are disclosed for rendering images of a scene using splatting with triangle primitives. A computing device performing the rendering can generate a plurality of triangles. Each of the plurality of triangles can be characterized by a plurality of opacity values and a color value. The computing device can determine a virtual screen for the image having a plurality of tiles. For each tile of the plurality of tiles, the computing device can determine a collection of the plurality of triangles overlapping a field of view of the tile, sort the collection of the plurality of triangles according to a distance from the tile, and compute pixel values for the tile by blending the color values of each triangle in the sorted collection of triangles based at least in part on an opacity value of each triangle.

### CROSS-REFERENCES TO OTHER APPLICATIONS

This application claims the benefit of U.S. Provisional Application No. 63/743,346, for “TECHNIQUES FOR IMAGE RENDERING USING TRIANGLE PRIMITIVES” filed on Jan. 9, 2025, which is herein incorporated by reference in its entirety for all purposes.

### BACKGROUND

Volume rendering techniques can be used for fast or real-time generation of realistic images of scenes from three-dimensional scene data, as well as reconstructing the scene data itself. Recent developments include neural radiance field rendering and 3D Gaussian splatting, in which optimization-based reconstruction of the underlying scene data from a given image collection allows for fast rendering from multiple viewpoints. However, these existing techniques may require additional, intensive processing of scene primitives to obtain accurate reconstructions.

### BRIEF SUMMARY

Embodiments of the present disclosure relate to techniques for rendering images of three-dimensional scenes using an improvement on 3D Gaussian splatting using triangle primitives. More particularly, embodiments of the present disclosure provide methods, computer devices, and computer-readable media that can generate a reconstruction of a scene based on triangle primitives using reference images, optimize the reconstruction and therefore the triangle primitives, and then render images from the reconstruction to provide views of the scene for use in various applications including presenting images for visualization of 3D content, mapping, video, virtual reality, and the like. The image rendering process improves on Gaussian splatting by using triangle primitives that have advantageous properties over the 3D Gaussian splats used in the Gaussian splatting. In doing so, the image rendering process can more quickly render images of the scene in real time or near real time while producing images that more accurately represent details of the scene.

One embodiment is directed to a method of rendering an image of a scene performed by a computing device. The method can include generating a plurality of triangles. Each of the plurality of triangles can be characterized by a plurality of 3D-coordinates, color, and opacity values. The method can also include determining a virtual screen for the image. The virtual screen can have a pose relative to the scene and comprising a plurality of tiles. The method can also include, for each tile of the plurality of tiles, determining a collection of the plurality of triangles overlapping a field of view of the tile. The field of view can be defined by the pose of the virtual screen. The method can also include sorting the collection of the plurality of triangles according to a distance from the tile to each triangle in the collection of triangles and computing pixel values for the tile by blending the color values of each triangle in the sorted collection of triangles based at least in part on an opacity value of the plurality of opacity values of each triangle in the sorted collection of triangles.

Another embodiment is directed to another method for rendering images of a scene. The method can include obtaining a plurality of triangles. Each of the plurality of triangles can be characterized by an opacity function and a color value. The method can also include determining a virtual screen for the image. The virtual screen can have a pose relative to the scene and comprising a plurality of pixels. The method can also include determining pixel values for the virtual screen by performing alpha blending for a subset of the plurality of triangles corresponding to each of the plurality of pixels. The alpha blending can be at least in part on the color value and opacity function of each triangle of the subset of the plurality of triangles.

Another embodiment is directed to a computing device that includes one or more processors and one or more memories storing instructions that, when executed by the one or more processors, cause the computing device to perform any of the methods described above.

Still another embodiment is directed to a non-transitory computer-readable medium storing computer-executable instructions that, when executed by one or more processors of a computing device, cause the computing device to perform any of the methods described above.

### BRIEF DESCRIPTION OF THE DRAWINGS

FIG. 1 illustrates a simplified block diagram of a technique to render an image using triangle primitives, according to some embodiments.

FIG. 2 illustrates an example triangle primitive characterized by color and opacity values, according to some embodiments.

FIG. 3A is a diagram illustrating imaging a scene to produce a representation of the scene, according to some embodiments.

FIG. 3B illustrates a plurality of triangles generated from a point cloud representation of the scene imaged in FIG. 3A, according to some embodiments.

FIG. 4 illustrates a selection of the plurality of triangles that overlap a field of view of a tile of a virtual screen used to render an image, according to some embodiments.

FIG. 5 illustrates sorting a collection of triangles according to a distance from the tile, according to some embodiments.

FIG. 6 illustrates an example architecture of a system that can implement techniques for image rendering using triangle primitives, according to some embodiments.

FIG. 7 illustrates an example process for rendering an image using triangle primitives, according to some embodiments.

FIG. 8 illustrates another example process for rendering an image using triangle primitives, according to some embodiments.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Examples of the present disclosure are directed to, among other things, methods, systems, and computer-readable media for rendering images of a three-dimensional scene using a technique referred to herein as “triangle splatting,” an improvement on a recent rendering technique called 3D Gaussian splatting. In the conventional Gaussian splatting, a given static scene is constructed using three dimensional Gaussian primitives defined by a three-dimensional covariance matrix, comparable to an ellipsoid. The Gaussian primitives are used to encode the alpha (opacity) values and color (e.g., RGB) for splat rendering of the scene. This 3D Gaussian primitive can then be projected to a two-dimensional representation to allow for rendering. However, this projection, as well as other preprocessing and linearization steps, requires additional computational effort when rendering an image. Moreover, the linearization of the camera transform results in an approximation of the 3D Gaussian primitives, in order to achieve real-time or near real-time processing.

Triangle splatting, as described herein, uses triangles oriented in the three-dimensional space to represent the scene. As compared to a 3D Gaussian primitive, a triangle has a well-defined shape and surface normal within the three-dimensional space of the scene. Each triangle can encode a spatially-varying opacity value (α) and a view-dependent color value. Then, starting from a collection of images of a static scene, or a point cloud representation of the scene, a collection of such triangles can be generated and optimized to represent the scene. By appropriately defining the spatially-varying opacity values for each triangle, these rendering operations maintain differentiability with respect to the entire scene representation, allowing for optimization-based reconstruction of the 3D scene by minimizing an image rendering error. Moreover, triangles ensure efficient exact projection through the projective transform of the standard pinhole camera model for rendering.

In addition, the conventional 3D Gaussian splatting suffers from deleterious effects due to global sorting of the Gaussian primitives during rendering. For example, “popping” artifacts may occur when rendering novel views of the scene due to global sorting of the Gaussian primitives during the rendering process. The popping artifacts may be visible image-to-image in a sequence of rendered images due to certain primitives being sorted closer to the image camera position then is actually indicated by the scene, resulting in regions of the rendered images “popping” to a different color/luminosity value from the alpha blending in that region. Triangle splatting overcomes this limitation by performing, during the rendering process, block-based sorting for different portions of a rendered image and then enforcing a per-pixel sorting correction buffer to allow for accurate rendering per pixel in each block using the viewable triangles in the scene.

As a particular example of a rendering pipeline using triangle splatting, consider the rendering of overhead images of terrain and buildings commonly presented in map applications for navigation on user devices. In particular, a portion of city including roads (as part of the navigational elements of the map application) and a various buildings and smaller scale structure like trees, foliage, and other vegetation can be rendered to present a view of that portion of the city for easy user navigation. The underlying scene data can be generated from aerial imagery taken from one or more cameras aboard aircraft or satellites. By implementing standard structure from motion (SfM) techniques, a point cloud representation can be generated for the scene. Using the point cloud and the reference camera images, a plurality of triangle primitives can be generated for the scene, each having a color value and opacity values defined for each point within the triangle. Then, to render a view of the scene (e.g., for a selected orientation of the view of the map image displayed at the user device), the plurality of triangles that are viewable from an image “screen” corresponding to the desired view are selected. The image screen is divided into blocks of pixels and the viewable triangles are sorted according to their distance from each block. Then, the triangles are alpha blended according to their color value and opacity value as determined by the projection onto each pixel, beginning with the “nearest” triangle to each pixel. Other examples can include three dimensional representations of interior scenes used as part of augmented reality or virtual reality (AR/VR) representations, in which the scene data is generated using camera views of the interior space.

The techniques described herein provide a number of technical improvements to address a number of technical problems as compared to conventional systems and techniques. As briefly discussed above, triangle primitives provide significant computational advantages to 3D Gaussian primitives in a splat rendering pipeline. First, triangles can be exactly projected onto the virtual screen when rendering an image, allowing for accurate rendering without projection artifacts. Second, a triangle primitive does not need preprocessing in the same way as a 3D Gaussian primitive. For instance, the 3D Gaussian primitives are typically projected to a two-dimensional polygon billboard prior to rendering (in addition to the linearization steps that are performed). Third, triangle primitives have well defined depth and normal vectors in the three-dimensional space of the scene, allowing for more accurate reconstruction and alignment of the primitives with the reference image data when generating the scene model. Moreover, with the appropriate choice of spatially-varying opacity function on each triangle primitive, the rendering operation can preserve differentiability with respect to the triangle primitives that is characteristic of the conventional 3D Gaussian primitive, allowing for accurate computation of gradients during rendering, used for optimizing the 3D scene representation, while benefitting from the computation advantages provided by the triangle geometry.

In addition, the rendering process using triangle primitives that includes a per-pixel sorting correction can avoid popping and other artifacts that are present in a 3D Gaussian splatting technique. Such artifacts can arise from novel views of the scene (e.g., “new” views of the scene that do not closely correspond with reference images used to generate/optimize the scene data). By correctly sorting the triangle primitives per block of pixels in an image and then applying a per-pixel correction buffer, popping artifacts can be reduced or eliminated by performing the blending using correctly sorted triangles per pixel in the image. The combination of the advantages of both the triangle primitives themselves and the rendering process allows for high resolution and real-time rendering of scenes with lower computational overhead during both the scene generation/optimization process and the image rendering process. Triangle primitives also allow for accurate scene reconstruction for scenes that include complicated details like foliage interspersed with structures and other objects. In particular, small scale, fine structure like tree foliage and building edges and corners are rendered with noticeable loss of detail using conventional techniques like mesh rendering. These techniques also tend to produce trees with canopies that form blobs, while certain features of buildings like roof edges become visibly warped. By contrast, an image rendered using triangle splatting more accurately shows foliage details, including depth and fine structure within trees while also preserving the shape of long, narrow features of buildings. These and other advantages will be made clear with reference to the figures and the following description.

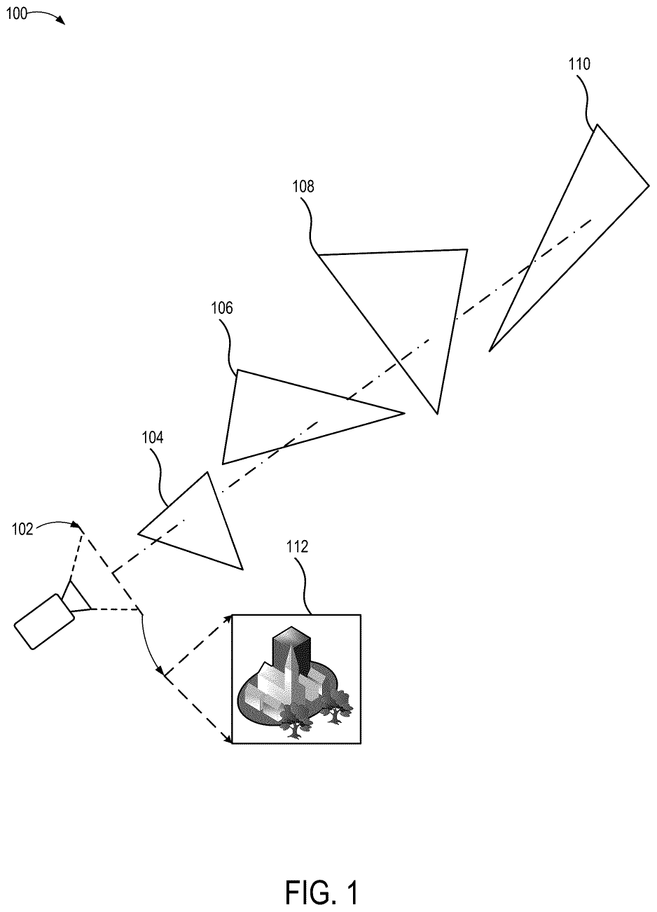

Turning now to the figures, FIG. 1 illustrates a simplified block diagram of a technique to render an image 112 using triangle primitives, according to some embodiments. The image 112 may be rendered from a plurality of triangle primitives 104-110 for a view defined by the orientation of a virtual image screen 102 or virtual camera. Each of the plurality of triangle primitives 104-110 may be a portion of a larger set of triangle primitives that comprise the reconstructed scene. For example, each triangle primitive may correspond to a point of a point cloud generated from images of a scene. The triangle primitives 104-110 may then be the triangle primitives that are viewable (overlap, in a sense) with the virtual image screen 102 for the rendered image 112.

With respect to the image screen 102, each triangle of the plurality of triangle primitives 104-110 may be oriented in the three-dimensional space of the scene. For instance, triangle 104 may be approximately normal to the image screen 102, so that the normal ray (shown by the dashed-dot line) from the image screen 102 is approximately normal to the triangle 104, while triangle 106 may be oblique to the normal ray. Because of the large number of triangle primitives that may be viewable from the image screen, various orientations of the triangles are possible. When rendering the image 112, each of the plurality of triangles 104-110 can be projected to each pixel of the image 112, so that the projection ray to each pixel intersects a point of one or more of the plurality of triangles 104-110. The triangles intersected along the projection ray will contribute color value to the image pixel value at that pixel.

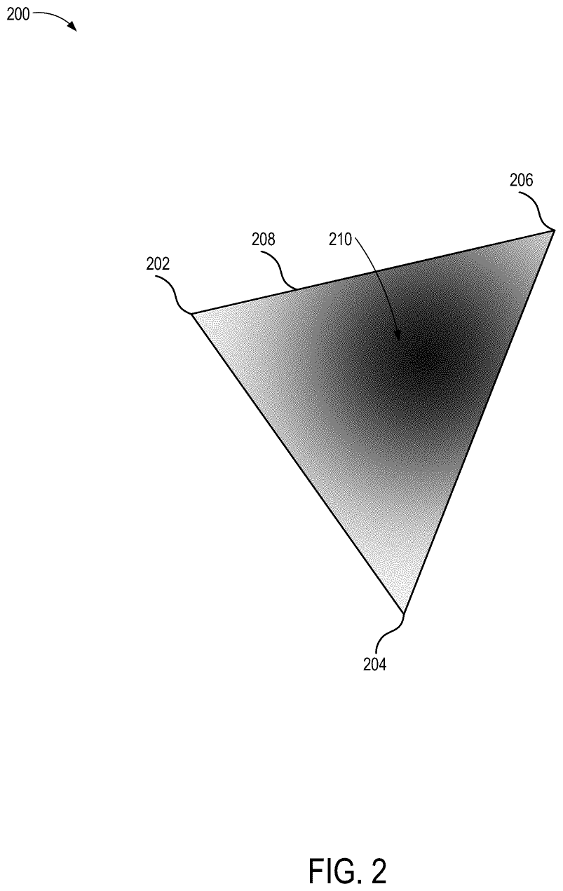

As described in more detail below with respect to FIG. 2, each triangle of the plurality of triangle primitives 104-110 can encode one or more visual parameters, including a color value and opacity values. The color value for each triangle may be fixed for each point of the triangle. For example, triangle 104 can have an RGB color value, while triangle 106 has a different RGB color value, and so on for triangle 108 and triangle 110. The color value may be constant for each point on the triangle. For example, each point on the boundary and interior of triangle 104 may have the same color value. In some embodiments, the color value for a given triangle primitive may be view dependent and may be different depending on the orientation of the image screen (e.g., image screen 102) used for rendering. For example, triangle 104 may have a first RGB color value when viewed from image screen 102 but have a second RGB color value when viewed from a different orientation (e.g., when rendering a different image of the scene from a different perspective). For the plurality of triangle primitives 104-110 that are viewable from the virtual screen 102, the image 112 may be rendered by alpha blending. Each point on the boundary and interior of the triangle primitives may have a corresponding opacity value (i.e., α) representing the relative contribution of that triangle's color value to the overall value of the pixel after blending. When projecting the plurality of triangles 104-110 to each pixel of the image 112, the opacity value of each triangle at the intersection of the projection ray with each triangle can be determined and used for blending. One skilled in the art will recognize many variations for accomplishing alpha blending according to embodiments described herein.

FIG. 2 illustrates an example triangle primitive 200 characterized by visual parameters including color and opacity values, according to some embodiments. The triangle primitive 200 may be an example of any of the plurality of triangle primitives 104-110 describe above with respect to FIG. 1. The triangle primitive 200 can be defined in the three-dimensional space of the corresponding scene by the position of its three vertices 202-206, which can provide an exact orientation of the face of the triangle primitive 200 in the three-dimensional space. Each point of the boundary (e.g., edge 208) and the interior of the triangle primitive 200 can then be defined in barycentric coordinates (b₀, b₁, b₂) of the triangle. For example, in barycentric coordinates, vertex 202 may be given by (1,0,0), vertex 204 by (0,1,0), and vertex 206 by (0,0,1), with the barycenter (i.e., centroid) of the triangle primitive 200 given by (⅓,⅓,⅓). The barycentric coordinates of the triangle primitive 200 can be readily transformed to the coordinate system of the scene.

The triangle primitive 200 can have a color value. For example, triangle primitive 200 can have a color value, in 8-bit RGB color space of (210, 40, 40), representing a red color. In some embodiments, a different color space can be used to represent the color of the triangle. For example, the color can be defined using an HSL color space (hue, luminance, and saturation), a luma/chroma (YUV) color space, or other color space. In some embodiments, in addition to an RGB value, the triangle primitive can also have a corresponding relative luminance value that can be used to transform from one color space representation to another. The color value may be constant throughout the triangle primitive 200. For example, each point of the triangle primitive can have the same RGB (210, 40, 40) color. However, embodiments in which the color value varies spatially for the triangle primitive 200 are contemplated.

Additionally, the color value for the triangle primitive 200 may be view dependent. For example, the triangle primitive 200 may have an RGB value of (210, 40, 40) when viewed (e.g., projected to) a particular direction when rendering an image, while having a different RGB value of (240, 90, 90) when viewed from a different direction. In some embodiments, depending on the color space used, the view-dependence may be used to vary the luminance depending on the view/projection direction of the rendering.

The triangle primitive 200 can also encode opacity values by way of an opacity function 210 defined over the points of the triangle primitive 200. The opacity function may be given in barycentric coordinates with respect to the triangle primitive, α(b₀,b₁,b₂). As depicted in FIG. 2, the opacity function 210 is shown by a gradient that peaks at the centroid of the triangle primitive 200 and smoothly decays to values of 0 at the edges of the triangle primitive 200. The opacity function 210 can be scaled to provide non-negative opacity values between 0 and 1. A particular opacity function 210 useful for the present techniques is given as α(b₀,b₁,b₂)=a·(27·b₀·b₁·b₂)^{γ}, where a is an opacity factor for the triangle primitive and γ is a hyperparameter that can be chosen (or allowed to vary during optimization of the scene reconstruction when generating the triangle primitives). Typically, the parameter γ is chosen to be 2, while the opacity factor may be chosen as a positive value between 0 and 1. The opacity function shown above provides the appropriate behavior of smoothly decaying to 0 at the edges of the triangle primitive 200 and reaching a maximum value of “a” at the barycenter of the triangle primitive 200. Other opacity functions may be selected to characterize the opacity values for a triangle primitive, according to some embodiments.

In addition to the color and opacity values described above, the triangle primitive 200 may also encode values for visual parameters including roughness, metallicness, and/or albedo. For example, a roughness parameter can characterize a roughness of the triangle primitive 200 that can be used to determine light scattering from the object rendered with the triangle primitive 200 when rendering the scene. Similarly, a metallicness parameter can characterize reflective properties of scene lighting from the triangle primitive 200. An albedo parameter for the triangle primitive 200 can be used in conjunction with the color value to define the color of the triangle primitive 200 in the absence of lighting and shading. In some examples, these additional visual parameters can have a single value for each triangle primitive. In other examples, the additional visual parameters can be defined over the area of the triangle primitive 200 using a function. In some embodiments, view-dependent information like the color, roughness, metallicness can be encoded as spherical harmonics or other parametric function associated with the primitives, including triangle primitive 200.

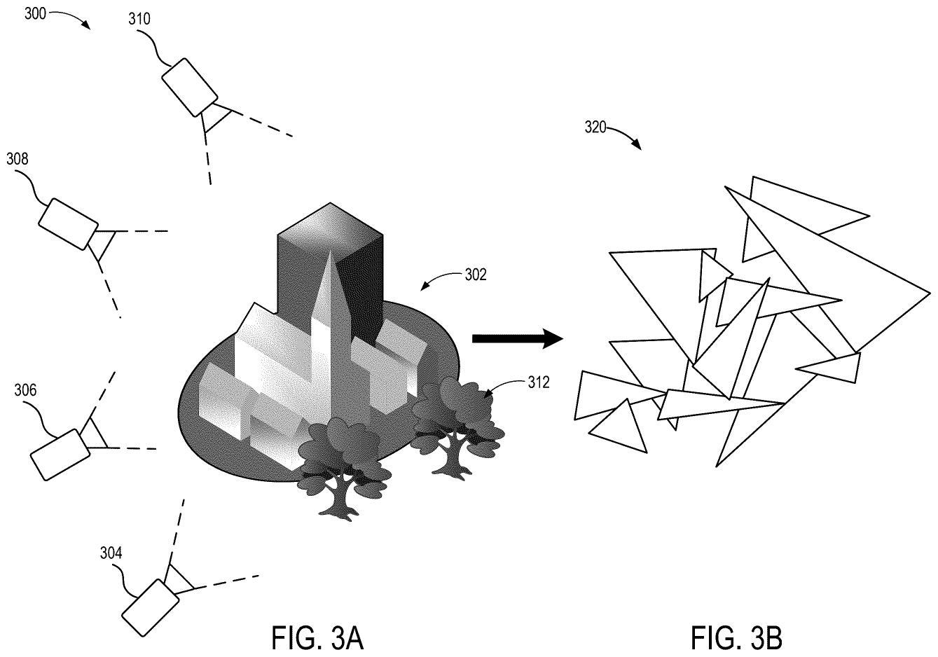

FIG. 3A is a diagram illustrating imaging a scene 302 to produce a representation of the scene, according to some embodiments. The scene 302 can be imaged by one or more cameras, depicted by cameras 304-310. In one exemplary embodiment, the scene 302 may be a location like a city or town, so that that the imaging of the scene is done using aerial cameras. For example, cameras 304-310 may represent the location of a camera on an aircraft overflying the scene 302 and taking an image at each location/orientation. The cameras 304-310 may then represent a sequence of images taken from a single camera moving around the scene 302. In other embodiments, the scene 302 may be imaged using multiple cameras at the same time or at different times. For instance, the scene 302 may be imaged by multiple cameras positioned around the scene 302.

The images from the cameras 304-310 can be used for reconstruction of the scene 302 by generating a model using triangle primitives. For example, a sequence of images of the scene 302 can be used in SfM techniques to generate a point cloud or mesh model representation of the scene 302. For example, sequential images (e.g., image from camera 304 and image from camera 306) can be used to compute depth to common points visible in each image based on motion parallax of the camera as it moves from the pose of the first image in the sequence to the next image in the sequence. Each image can have a pose (position and orientation) of the corresponding camera 304-310 that is determined when the image is acquired. For example, the cameras 304-310 may have an inertial or other sensor that can be used to determine the pose when an image is captured.

The scene 302 can include complicated details like trees 312. The foliage of trees may make reconstruction of a scene challenging due to the varying depths of different portions of the foliage and small-scale features. However, the use of triangle primitives to represent the scene during reconstruction can allow for an improved rendering due to the ability of the triangle primitives to more accurately fit the shape and depth of structures found in trees 312 and other complicated features of the scene 302 (e.g., building facades, roofing tiles, eaves, etc.).

FIG. 3B illustrates a plurality of triangles 320 generated from a point cloud representation of the scene 302 imaged in FIG. 3A, according to some embodiments. The plurality of triangles 320 may be an example of the triangle primitives 104-110 described above with respect to FIG. 1. The plurality of triangles 320 may be generated using a point cloud generated from images of the scene 302 captured using cameras 304-310. However, the point cloud is not required to generate the plurality of triangles 320. In some embodiments, the plurality of triangles can be generated from the reference images of the scene.

To generate the plurality of triangles 320, an initial set of triangles can be formed for the scene. Then, images from the reconstruction can be rendered using the poses of each camera/image of the scene 302. For example, the initial set of triangles can be used to render a corresponding image to the reference images taken from each of cameras 304-310. Based on a comparison of the rendered image to the reference image, the parameters of the set of triangles can be adjusted to minimize one or more loss functions. For example, the position of the vertices of the triangles 320 can be adjusted, which can correspond to changes in the orientation and shape of each triangle. In addition, the color of each triangle and/or the opacity function of each triangle can be adjusted during the reconstruction process.

The rendering/optimizing process can be repeated multiple times until a convergence in the loss function output is reached, or a predetermined number of iterations occurs, or other stopping point. Loss functions can include a photometric loss, geometry regularization losses (e.g., curvature, normals, etc.), and depth losses. In some embodiments, the reconstruction can be trained using a neural network or similar technique.

In some embodiments, the representation of the scene 302 can include both triangles 320 and a mesh model, for instance a triangle mesh or textured triangle mesh, with the triangles of the mesh being different objects than the triangles 320 used for splatting. In this “hybrid” model of the scene 302, the triangles 320 can be associated with the triangle mesh to improve the speed of rendering. For example, the triangles 320 can include triangle primitives that intersect a portion of a triangle mesh, thereby reducing the total number of triangle primitives used for the model of the scene 302. In other examples, the triangle mesh can be used to determine or refine the position/orientation of the triangles 320 that are generated from images of the scene, particularly in cases where a point cloud or mesh model were not used to construct the triangles 320 initially. Representing parts of the scene with a traditional triangle mesh can increase rendering efficiency by reducing the number of triangles 320 needed to perform triangle splatting. To render such a “hybrid” scene, the triangle mesh would be rendered normally in a first pass. The resulting depth buffer can then be used to determine the triangles 320 that are visible. The visible triangles 320 are then rendered on top of the rendered mesh image through alpha blending according to the techniques described herein.

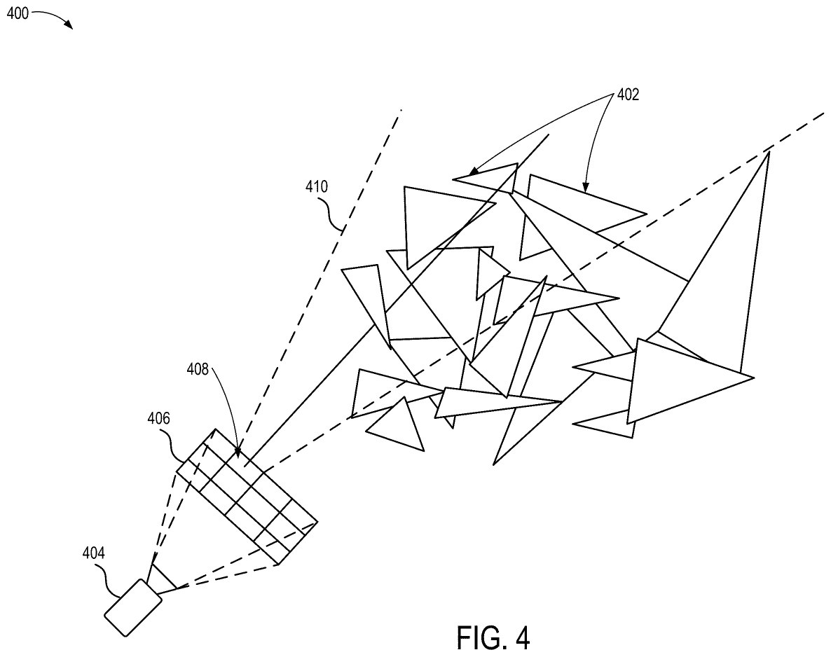

FIG. 4 illustrates a diagram 400 of a rendering process, according to techniques herein. As described briefly above, rendering an image from the plurality of triangles representing the scene can include an alpha blending process. For alpha blending, the contribution to each pixel of the rendered image from one or more of the plurality can be determined based on the color value modified by the opacity value of the triangle. Whether a triangle contributes to a pixel can be based on a projection from the pixel to the triangle, with triangles closer to the pixel in the virtual screen accounted for first. Because the number of triangles used to reconstruct the scene can be very large, and since only certain triangles “viewable” from the virtual screen of the image to be rendered, the rendering process can select a portion of the plurality of triangles portion of the plurality of triangles (e.g., the plurality of triangles 320 of FIG. 3) to perform the blending process for each pixel or blocks of pixels in the image.

As depicted in FIG. 4, the image to be rendered can be represented by a virtual screen 406 that corresponds to the image plane of a virtual camera 404 that has a pose. For example, the virtual screen 406 can include a plurality of pixels such that the rendering using the plurality of triangles will produce the image at the virtual screen. Based on the pose of the virtual camera 404, the view of the plurality of the triangles can be projected onto the virtual screen 406 according to a camera model (e.g., pinhole camera) or other projection model. Because the primitives are triangles, each of the plurality of triangles can be exactly projected to the virtual screen 406.

In the projection to the virtual screen 406, not every triangle primitive may be viewable from each pixel of the virtual screen 406. For example, some triangles of the plurality of triangles may have no point that projects to a pixel of the virtual screen, and so would not contribute during a blending process. To greatly improve the speed and reduce the computational complexity of the rendering process, a selection of the plurality of triangles can be determined for blending to groups of pixels in the virtual screen 406.

The virtual screen 406 can be divided into a plurality of tiles, including tile 408. Each tile can include a portion of the plurality of pixels of the virtual screen 406. For example, the virtual screen may be 1920 by 1080 pixels, with a plurality of 8×8 pixel tiles spanning the image (for a total of 32,400 tiles). The tiles can be larger or smaller than 8 x8 pixels. In some embodiments, different tiles of the virtual screen 406 may have different sizes than other tiles in the virtual screen. For example, tiles near the center of the image may be 8×8 pixels, while tiles near the edge of the image may be 16×16 pixels.

For each tile in the virtual screen 406, a selection of the plurality of triangles can be determined based on if they are “viewable” from the tile. That is to say, a portion of the triangle overlaps with a field of view of the tile (and can therefore project to at least one pixel in the tile. As shown in FIG. 4, a tile 408 can have a field of view 410 that is based on the projection model used for the virtual camera 404 and virtual screen 406. A collection 402 of the plurality of triangles can be determined based on the overlap of the triangles and the field of view 410. Each tile of the virtual screen 406 can have a corresponding selection of the plurality of triangles representing the scene. By determining the collection 402 of the plurality of triangles, the blending process for the pixels in the tile 408 can be improved by limiting the large number of triangles that can contribute to the pixel values of tile 408.

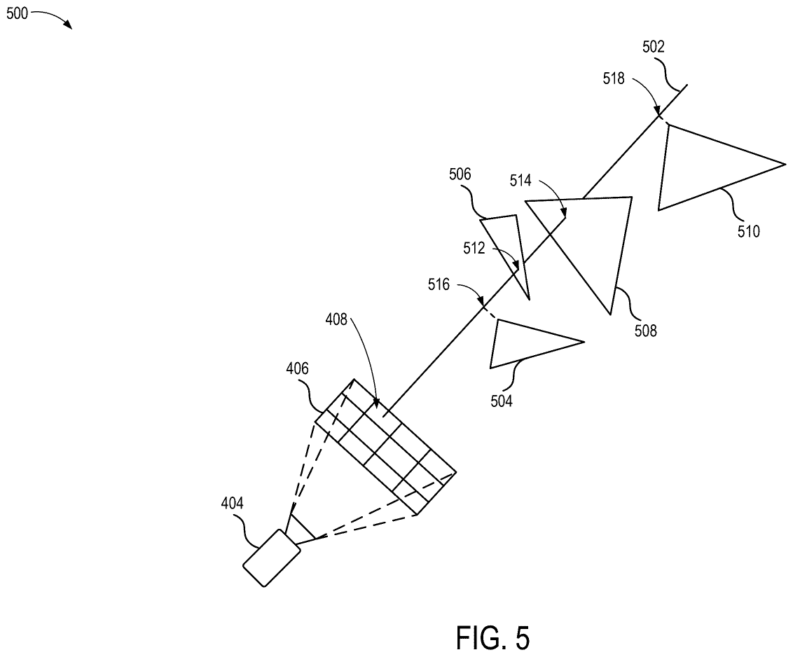

FIG. 5 illustrates another portion 500 of the rendering process for an image of the scene represented by a plurality of triangles, according to some embodiments. Once a collection of triangles (e.g., collection 402 of FIG. 4) is determined for tile 408, each of the triangles of the collection can be sorted according to a distance from the tile 408. The sorting of the collection of triangles can result in a list of the triangles arranged with the “nearest” triangle to the tile 408 occurring first, and then proceeding according to increasing distance. As depicted in FIG. 5, the collection of triangles can include triangles 504-510.

The distance from the tile 408 to each of the triangles 504-510 can be determined based on a projection ray 502 from the center of the tile 408. The projection ray 502 may be oriented relative to the virtual screen 406 based on the projection model of the virtual camera 404 and virtual screen 406. For example, the projection ray 502 may be oriented normal to the virtual screen 406.

Of the collection of triangles that are viewable from tile 408, some triangles may intersect with projection ray 502, while other triangles may not intersect with projection ray 502. For example, triangle 506 and triangle 508 intersect with projection ray 502, while triangle 504 and triangle 510 do not intersect with projection ray 502. To determine the distance from the tile 408 to each triangle, the distance along the projection ray 502 to either the intersection point with each triangle or the point of the triangle nearest to the projection ray 502 can be determined. For example, the nearest point of triangle 504 to projection ray 502 can be determined and mapped to point 516 on projection ray 502. Similarly, the nearest point of triangle 510 can be mapped to point 518 on projection ray 502. For intersection triangle 506 and triangle 508, the intersection points 512, 514 can be determined. A distance to each of points 512-518 from the center of tile 408 can be computed.

Sorting the collection of triangles can be done using a suitable sorting algorithm based on the distances. For example, a radix sort of the distances can be performed. The sorted collection of triangles can be stored in a buffer corresponding to the tile 408 for use when determining pixel values for each pixel in tile 408. The buffer can be a circular or ring buffer.

To determine a pixel value for a pixel in tile 408, alpha blending can be performed using the sorted collection of triangles 504-510 in the buffer. For example, the contribution of the triangles 504-510 to the pixel can be determined by blending beginning with the first triangle in the sorted collection and proceeding with the color values of successive triangles in the sorted collection until the opacity channel is filled. Because the collection of triangles was sorted with respect to the center of the tile 408 and not each individual pixel, for some pixels the “first” triangle in the buffer may not be the closest triangle to the pixel when blending. To correct for this, the nearest triangle to each pixel can be determined and then that triangle's position in the buffer can be selected as the start for the blending process, with the blending proceeding to the next triangle in the buffer. Such a correction can improve the rendering process without needing to resort the entire collection of triangles 504-510 for each pixel in the tile 408.

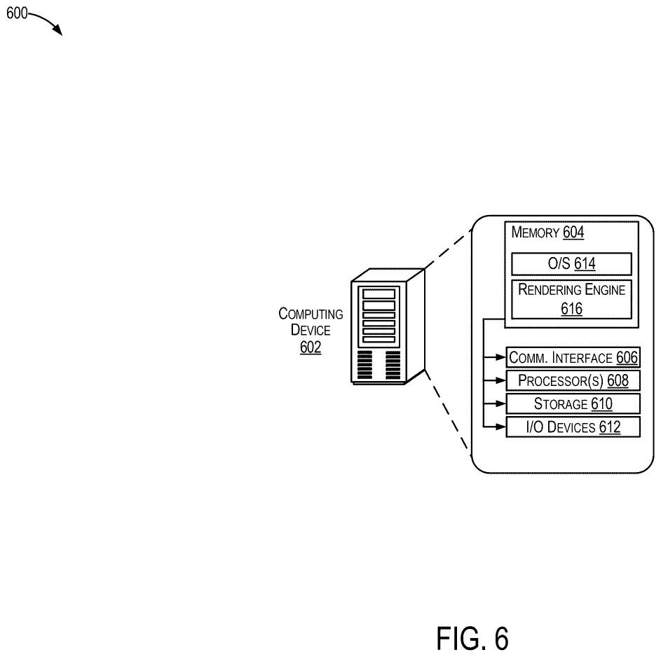

FIG. 6 illustrates an example architecture of a system 600 that can implement techniques for image rendering using triangle primitives, according to some embodiments. The system 600 includes a computing device 602. The computing device 602 can be one or more remote computing devices, including cloud devices. In some embodiments, at least some elements of system 600 may be used to perform scene reconstruction and image rendering using triangle splatting with triangle primitives (e.g., triangle 200 of FIG. 2).

The computing device 602 can be any suitable type of computing system including, but not limited to, a laptop computer, a desktop computer, a mobile phone, a smartphone, a server computer, etc. In some embodiments, the computing device 602 is executed by one or more virtual machines implemented within a cloud computing or other hosted environment. The cloud computing environment may include provisioned computing resources like compute, storage, and networking. The computing device 602 can communicate with one or more user devices via a network connection. The computing device 602 may be configured to implement the functionality described herein as part of a distributed computing environment. In some embodiments, the computing device 602 may be a portion of an AR/VR system, including peripherals like a headset that can present rendered images to a user via a wearable display.

The computing device 602 can include a memory 604, one or more processor(s) 608, I/O devices 612, and at least one storage unit 610. The processor(s) 608 may be implemented as appropriate in hardware, computer-executable instructions, software, firmware, or combinations thereof. Computer-executable instruction, software, or firmware implementations of the processor(s) 608 may include computer-executable or machine-executable instructions written in any suitable programming language to perform the various functions described. The memory 604 may store program instructions that are loadable and executable on the processor(s) 608, as well as data generated during the execution of these programs. Depending on the configuration and type of memory included in the computing device 602, the memory 604 may be volatile (such as RAM) and/or non-volatile (such as read-only memory (“ROM”), flash memory, or other memory). In some embodiments, the storage 610 may include one or more databases, data structures, data stores, or the like for storing and/or retaining information associated with the computing device 602. The storage 610 may include data stores for storing image information and scene reconstruction information usable to perform triangle splatting. For example, references images of a scene taken from one or more cameras like cameras 304-310 of FIG. 3A can be stored in storage 610 and used to perform scene reconstruction.

The memory 604 may include an operating system (O/S) 614 and one or more application programs, components, or services for implementing the features disclosed herein, including rendering engine 616. The rendering engine 616 may be configured to both perform scene reconstruction, including generating point cloud representations of a scene from reference images and generating triangle primitives, and render images from a plurality of triangle primitives representing the scene using alpha blending or other rendering technique. In some embodiments, the storage 610 may include one or more databases, data structures, data stores, or the like for storing and/or retaining information associated with the computing device 602. In some embodiments, the rendering engine 616 can generate images of a scene for use with one or more other applications that execute on computing device 602 or another user device. For example, images of a scene used for a map application on a user device can be rendered by rendering engine 616, optionally stored (e.g., in storage 610), and transmitted to the user device for display with the map application.

The computing device 602 may contain a communications interface 606 that allows the computing device 602 to communicate with another computing device or server, a user device, a stored database, or a third-party service provider. The computing device 602 may also include I/O device(s) 612, such as for enabling connection with a keyboard, a mouse, a pen, a voice input device, a touch input device, a display, speakers, a printer, etc.

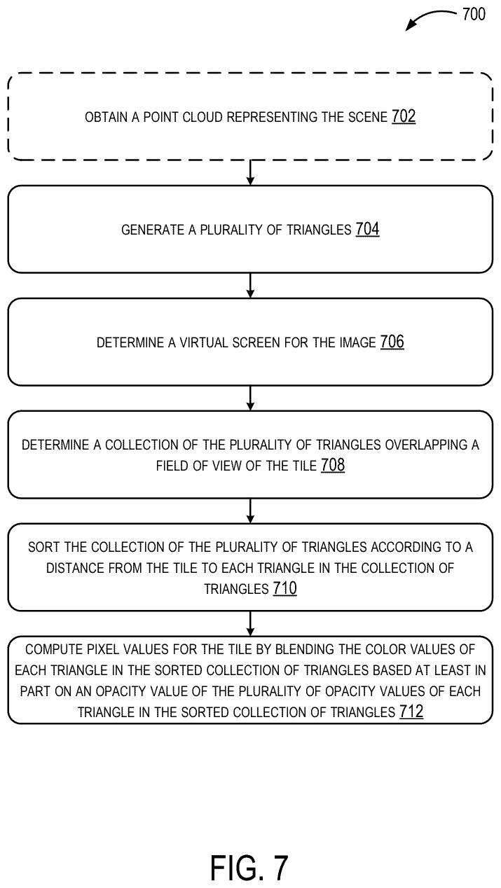

FIG. 7 illustrates an example process 700 for rendering an image using triangle primitives, according to some embodiments. The process 700 can be performed by a computing device (e.g., computing device 602 of FIG. 6) executing a rendering engine (e.g., rendering engine 616 of FIG. 6).

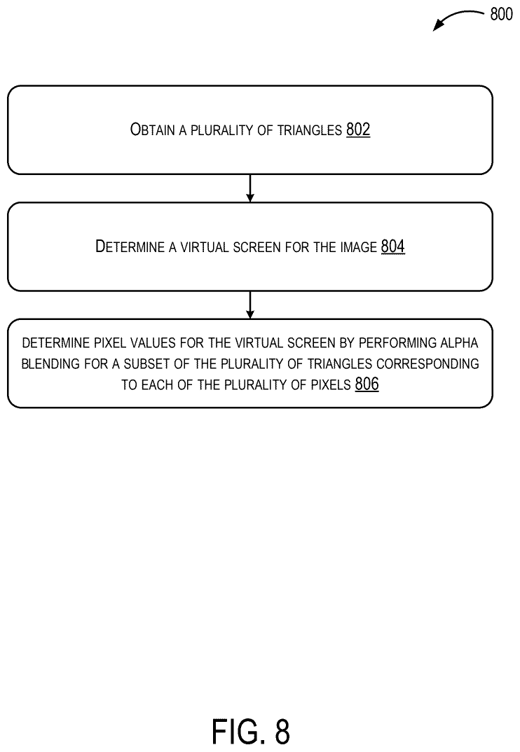

The process 700 and any other process described herein (e.g., process 800 of FIG. 8) are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

In some embodiments, the process 700 can begin at block 702, by the computing device obtaining a point cloud representing the scene. The point cloud can include a plurality of points representing surfaces of objects in the scene and having coordinates in the three-dimensional space of the scene. In some embodiments, obtaining the point cloud can include generating the point cloud from a plurality of historical images (reference images) of the scene, for example using SfM techniques. In some embodiments, the historical images can be captured using one camera or can be captured using a plurality of cameras. In other embodiments, obtaining the point cloud can include retrieving the point cloud from storage (e.g., storage 610 of FIG. 6). However, a point cloud representation of the scene is not a requirement for the following operations of process 700.

At block 704, the computing device can generate a plurality of triangles corresponding to the scene. The plurality of triangles can be triangle primitives described herein for use with triangle splatting, including triangle 200 of FIG. 2. The plurality of triangles can be generated from reference images of the scene. In embodiments where a point cloud is used, each of the plurality of triangles can correspond to a point of the plurality of points of the point cloud. For example, the points of the point cloud can be used to determine the location and orientation of a corresponding triangle. Each triangle of the plurality of triangles can be characterized by a plurality of opacity values and a color value. For example, each point on the interior and edges of the triangle can have an opacity value defined by an opacity function. The opacity function can decrease to zero at the edges each of the plurality of triangles. In some embodiments, the opacity function is defined by α=a·(27·b₀·b₁·b₂)γ, where α is the opacity value at a point on the triangle, a is an alpha parameter for the corresponding triangle, b₀, b₁, and b₂ are barycentric coordinates of the point of the corresponding triangle, and γ is a hyperparameter. In some embodiments, the color value may be constant for a give triangle, so that any point on the interior or edges of the triangle has the same color value. In some embodiments, the color value may be view dependent. For example, for a projection that corresponds to a given camera pose, the color value of the triangle may have a first value, while for the projection corresponding to another camera pose, the color value of the triangle may have a second value. Each different triangle of the plurality of triangles can have a different color value and opacity function defining its opacity values.

In some embodiments, generating the plurality of triangle can include an iterative, machine-learning process whereby an initial set of triangles is generated from reference images of the scene (or from a point cloud), then trained using the reference images to determine the parameters of the plurality of triangles. The iterative process can include minimizing one or more loss functions corresponding to photometric loss, geometry regularization losses (e.g., curvature, normals, etc.), and depth losses. At each step of the iterative process, the values of the loss functions can be determined by rendering images from the plurality of triangle primitives for camera poses corresponding to the reference images used to generate the triangle primitives and then comparing the rendered images to the corresponding reference images. The parameters of the plurality of triangles that can be varied during the training process can include the location in three dimensions of the vertices of each triangle (which will vary the shape and orientation of the triangle), the color value of each triangle, the view-dependence of the color value of each triangle, and the opacity functions of each triangle. In some embodiments, the opacity functions of each triangle can include a hyperparameter that may be fixed during the iterative training process or may be allowed to vary during the training process. In some instances, the hyperparameter may be adjusted in a separate process (e.g., hyperparameter tuning) than the process used to adjust the other parameters of the plurality of triangles.

In some embodiments, the operations described above with respect to blocks 702 and 704 can be performed to reconstruct the scene using the plurality of triangle primitives. This reconstruction including the plurality of triangles can be stored for subsequent use when rendering images of the scene. The operations described below with respect to blocks 706-812 include operations to render the image from this reconstructed scene data.

At block 706, the computing device can determine a virtual screen (e.g., virtual screen 406 of FIG. 4) for the image to be rendered. For example, a user may select a position and orientation for viewing the reconstructed scene in an application. To display the selected view, the position and orientation of the virtual screen can be determined based on the pose of a virtual camera that can be considered as “capturing” the image of the scene. Based on the pose of the virtual camera and the camera model used for projecting the image onto the virtual screen, the virtual screen's pose (position and orientation with respect to the coordinate system of the scene) can be determined. The virtual screen can include a plurality of pixels, which can correspond to the pixels of the image to be rendered. For example, the virtual screen may be 1920 by 1080 pixels. The virtual screen may be divided into a plurality of tiles. Each tile may represent a portion of the plurality of pixels of the virtual screen. For example, in some embodiments, each tile may be an 8-pixel by 8-pixel array.

The operations described below with respect to blocks 708-812 can be performed for each tile. In some embodiments, the operations of blocks 708-812 may be performed in parallel to improve the rendering speed of the image. At block 708, the computing device can determine a collection of the plurality of triangles that overlap a field of view (e.g., field of view 410 of FIG. 4) of the tile. The field of view of the tile can be defined by the pose of the virtual screen. For example, from the entire collection of triangle primitives for the scene, the projection to the tile on the virtual screen may not include many of the triangles. The triangles that do not overlap the field of view can be excluded from the blending process for the pixels of the tile.

At block 710, the computing device can sort the collection of the plurality of triangles according to a distance from the tile to each triangle in the collection of triangles. For example, of the collection of triangles that overlap the tile's field of view, a distance to each triangle from the center of the tile can be determined. The distance can be relative to a projection ray (e.g., projection ray 502 of FIG. 5) that is projected from the center of the triangle that either intersects each triangle or passes a nearest point of each triangle. The distance can then be the distance along the projection ray to the intersection point or the nearest point. To sort the collection of triangles, the computing device can perform a radix sort or other suitable sorting algorithm to create a list of the triangles arranged according to the distance to the virtual screen. In some embodiments, the sorted collection of triangles may be stored in a circular buffer during the blending process. In some embodiments, the sorted collection of triangles may be stored in a linear buffer during the blending process.

At block 712, the computing device can compute pixel values for the tile by blending the color values of each triangle in the sorted collection of triangles based at least in part on an opacity value of the plurality of opacity values of each triangle in the sorted collection of triangles. For example, the blending process can determine a contribution of the color value to a pixel value of the tile from the first (e.g., nearest) triangle to the pixel. Then, the next nearest triangle in the sorted collection can be used to determine the contribution of its color value to the pixel value, and so on until the blending process is complete based on the opacity value of each triangle used. In some embodiments, the blending process can include alpha blending. In some embodiments, the pixel values for the tile can be computed in parallel. In some embodiments, the triangles in the circular buffer can be used to provide a per-pixel correction to the sorting that was determined referencing the center of the tile. When computing a pixel value of the tile, the triangle nearest to the pixel may be selected as the first triangle in the circular buffer with which to begin the blending process to compute the pixel value. A next triangle can then be sorted into the circular blending based on its distance.

In some embodiments, the image rendered according to process 700 can be presented at a display of another computing device. The image can include the pixel values for each tile of the virtual screen.

FIG. 8 illustrates another example process 800 for rendering an image using triangle primitives, according to some embodiments. Some of the operations of process 800 may be similar to operations described above with respect to process 700 of FIG. 7. Process 800 can be performed by a computing device (e.g., computing device 602 of FIG. 6) executing a rendering engine (e.g., rendering engine 616 of FIG. 6).

The process 800 can begin at block 802 with the computing device obtaining a plurality of triangles. Each of the plurality of triangles can be characterized by an opacity function and a color value. The plurality of triangles may be generated from historical images of the scene. In some embodiments, the plurality of triangles may be generated using a point cloud. The opacity function can decrease to zero at the edges each of the plurality of triangles. In some embodiments, the opacity function is defined by α=a·(27·b₀·b₁·b₂)γ, where α is the opacity value at a point on the triangle, a is an alpha parameter for the corresponding triangle, b₀, b₁, and b₂ are barycentric coordinates of the point of the corresponding triangle, and γ is a hyperparameter. In some embodiments, obtaining the plurality of triangles can include generating the plurality of triangles. In some embodiments, obtaining the plurality of triangles can include retrieving the plurality of triangles from a data store or other computer storage device or system. For example, a prior scene reconstruction process may have been performed to generate the plurality of triangles representing a scene. This plurality of triangles may be obtained by the computing device for use when rendering images of the scene.

In some embodiments, generating the plurality of triangle can include an iterative, machine-learning process whereby an initial set of triangles is generated from reference images of the scene (or from a point cloud), then trained using the reference images to determine the parameters of the plurality of triangles. The iterative process can include minimizing one or more loss functions corresponding to photometric loss, geometry regularization losses (e.g., curvature, normals, etc.), and depth losses. At each step of the iterative process, the values of the loss functions can be determined by rendering images from the plurality of triangle primitives for camera poses corresponding to the reference images used to generate the triangle primitives and then comparing the rendered images to the corresponding reference images. The parameters of the plurality of triangles that can be varied during the training process can include the location in three dimensions of the vertices of each triangle (which will vary the shape and orientation of the triangle), the color value of each triangle, the view-dependence of the color value of each triangle, and the opacity functions of each triangle. In some embodiments, the opacity functions of each triangle can include a hyperparameter that may be fixed during the iterative training process or may be allowed to vary during the training process. In some instances, the hyperparameter may be adjusted in a separate process (e.g., hyperparameter tuning) than the process used to adjust the other parameters of the plurality of triangles.

At block 804, the computing device can determine a virtual screen for the image. The virtual screen can have a pose relative to the scene and include a plurality of pixels.

At block 806, the computing device can determine pixel values for the virtual screen by performing alpha blending for a subset of the plurality of triangles corresponding to each of the plurality of pixels. The alpha blending can use the color value and opacity function of each triangle of the subset of the plurality of triangles. In some embodiments, the subset of the plurality of triangles includes triangles that overlap a field of view of a portion of the virtual screen. In some embodiments, the subset of the plurality of triangles are sorted based on a distance from the portion of the virtual screen to a corresponding triangle of the subset of the plurality of triangles.

Illustrative methods and devices for using data exchange options in a data exchange session are described above. Some or all of these devices and methods may, but need not, be implemented at least partially by architectures such as those shown at least in FIG. 6. Further, in the foregoing description, various non-limiting examples were described. For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

The various examples further can be implemented in a wide variety of operating environments, which in some cases can include one or more user computers, computing devices or processing devices which can be used to operate any of a number of applications. User or client devices can include any of a number of general-purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network. Particular implementations can include augmented reality and/or virtual reality (AR/VR) systems, including AR/VR headsets and associated computing systems.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C #or C++, or any scripting language, such as Perl, Python or TCL, as well as combinations thereof. The server(s) may also include database servers, including without limitation those commercially available from Oracle®, Microsoft®, SAP®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from those described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

As described above, one aspect of the present technology can include the gathering, use, and storage of data including images for use in image rendering and scene reconstruction. The present disclosure contemplates that in some instances, this gathered data may include personally identifiable information (PII) data that uniquely identifies or can be used to contact or locate a specific person, including image metadata and identifiable features in the images themselves. Such personal information data can include demographic data, location-based data (e.g., GPS coordinates), telephone numbers, email addresses, social media handles and/or ID's, home addresses, or any other identifying or personal information.

The present disclosure recognizes that the use of such personal information data, in the present technology, can be used to the benefit of users. For example, the image data can be used to render images of a reconstructed scene.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of services related to tracking a user's location or including location metadata with image data (e.g., via the user's mobile device), the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

All references, including publications, patent applications, and patents cited herein are hereby incorporated by reference to the same extent as if each reference were individually and specifically indicated to be incorporated by reference and were set forth in its entirety herein.

What is claimed is:

1. A method for rendering an image of a scene, the method comprising:
generating a plurality of triangles, each of the plurality of triangles characterized by a plurality of opacity values and a color value;
determining a virtual screen for the image, the virtual screen having a pose relative to the scene;
determining a collection of the plurality of triangles overlapping a field of view of the virtual screen, the field of view defined by the pose of the virtual screen;
sorting the collection of the plurality of triangles according to a distance from the virtual screen to each triangle in the collection of triangles; and
computing pixel values for the virtual screen by blending the color values of each triangle in the sorted collection of triangles based at least in part on an opacity value of the plurality of opacity values of each triangle in the sorted collection of triangles.

2. The method of claim 1, wherein the plurality of opacity values for each of the plurality of triangles are defined by an opacity function, the opacity function decreasing to zero at edges of each of the plurality of triangles.

3. The method of claim 2, wherein the opacity function defines the opacity value based at least in part on an alpha parameter is defined for the corresponding triangle, barycentric coordinates of a point of the corresponding triangle, and a hyperparameter.

4. The method of claim 1, wherein the color value of each of the plurality of triangles is characterized by the pose of the virtual screen.

5. The method of claim 1, wherein computing the pixel values for each tile comprises performing alpha blending.

6. The method of claim 1, wherein generating the plurality of triangles comprises generating the plurality of triangles from historical images of the scene.

7. The method of claim 6, wherein the historical images are captured using one camera.

8. The method of claim 6, wherein the historical images are captured using a plurality of cameras.

9. The method of claim 1, wherein computing pixel values for the virtual screen comprises, for each pixel of the virtual screen:
sorting a portion of the collection of the plurality of triangles into a circular buffer until the circular buffer is full or no other triangles remain;
removing a first triangle from the circular buffer; and
blending the first triangle into the pixel value.

10. A computing device, comprising:
one or more processors; and
one or more memories storing computer-executable instructions that, when executed by the one or more processors, cause the computing device to execute an application configured to perform operations comprising:
generating a plurality of triangles representing a scene, each of the plurality of triangles characterized by a plurality of opacity values and a color value;
determining a virtual screen for an image of the scene, the virtual screen having a pose relative to the scene, the virtual screen comprising a plurality of tiles;
determining a collection of the plurality of triangles overlapping a field of view of the virtual screen, the field of view defined by the pose of the virtual screen;
sorting the collection of the plurality of triangles according to a distance from the virtual screen to each triangle in the collection of triangles; and
computing pixel values for the virtual screen by blending the color values of each triangle in the sorted collection of triangles based at least in part on an opacity value of the plurality of opacity values of each triangle in the sorted collection of triangles.

11. The computing device of claim 10, wherein sorting the collection of the plurality of triangles comprises, for each tile of the plurality of tiles:
projecting a ray from a center of the tile;
determining intersections of the ray with the triangles of the collection of triangles;
determining the distance from the center of the tile to the intersections; and
ordering the collection of triangles according to the distance of each triangle of the collection of triangles.

12. The computing device of claim 10, wherein sorting the collection of the plurality of triangles comprises:
projecting a ray from a center of the tile;
determining a nearest point of each triangle of the collection of triangles to the ray;
determining the distance from the center of the tile to the nearest point of each triangle; and
ordering the collection of triangles according to the distance of each triangle of the collection of triangles.

13. The computing device of claim 10, wherein each tile of the plurality of tiles comprises a plurality of pixels of the image.

14. The computing device of claim 10, wherein each tile of the plurality of tiles comprises an 8-pixel by 8-pixel array.

15. The computing device of claim 10, wherein computing the pixel values is performed in parallel for each tile of the plurality of tiles.

16. The computing device of claim 10, further comprising presenting the image comprising the pixel values of the virtual screen at a display of the computing device.

17. One or more non-transitory computer-readable media storing computer-executable instructions that, when executed by one or more processors, cause the one or more processors to execute an application configured to perform operations comprising:
generating a plurality of triangles representing a scene, each of the plurality of triangles characterized by one or more visual parameters;
determining a virtual screen for an image of the scene, the virtual screen having a pose relative to the scene, the virtual screen comprising a plurality of tiles;
determining a collection of the plurality of triangles overlapping a field of view of the virtual screen, the field of view defined by the pose of the virtual screen;
sorting the collection of the plurality of triangles according to a distance from the virtual screen to each triangle in the collection of triangles; and
computing pixel values for the virtual screen based in part on the one or more visual parameters.

18. The one or more non-transitory computer-readable media of claim 17, wherein the one or more visual parameters comprise a color value and a plurality of opacity values for each triangle of the plurality of triangles, and wherein computing the pixel values comprises blending the color values of each triangle in the sorted collection of triangles based at least in part on an opacity value of the plurality of opacity values of each triangle in the sorted collection of triangles.

19. The one or more non-transitory computer-readable media of claim 18, wherein the plurality of opacity values decrease smoothly to zero at edges of each of the plurality of triangles.

20. The one or more non-transitory computer-readable media of claim 17, wherein the one or more visual parameters comprise a roughness parameter, a metallicness parameter, or an albedo parameter, and wherein determining the pixel values further comprises computing a light value based at least in part on the roughness parameter, a metallicness parameter, or an albedo parameter.
